(19) United States
(12) Patent Application Publication
(10) Pub. No.: US 2004/0179278 A1
(43) Pub. Date: Sep. 16, 2004

(54) Heat sink assembly for a microscope

(75) Inventors: Russell Bonaventura, Williamsville, NY (US); Paul M. Harrison, Alden, NY (US); Kenneth M. Northem, West Seneca, NY (US); Scott W. Parks, East Amherst, NY (US)

Correspondence Address: C. Paul Maliszewski, P.E., Simpson & Simpson, PLLC, 5555 Main Street, Williamsville, NY, 14221-5406, US

(73) Assignee: Leica Microsystems Wetzlar GmbH, Wetzlar (DE)

(21) Appl. No.: 10/811,345

(22) Filed: Mar. 26, 2004

Related U.S. Application Data
(63) Continuation-in-part of application No. 10/244,354, filed on Sep. 16, 2002.

(51) Int. Cl. G02B 21/06; G02B 7/02

(52) U.S. Cl. 359/820

(57) ABSTRACT

A heat sink assembly for a microscope including a baffle plate located proximate an air inlet of a microscope and a heat sink located proximate the baffle plate. The baffle plate is arranged to enable the passage of air through the air inlet while occluding the emanation of light from the microscope through the air inlet. The baffle plate and heat sink are arranged to induce airflow through the baffle plate, across the heat sink, and out an air outlet for the microscope.

### CROSS-REFERENCE TO RELATED APPLICATIONS

The instant application is a Continuation-In-Part of U.S. patent application Ser. No. 10/244,354 filed Sep. 16, 2002.

### FIELD OF THE INVENTION

The present invention relates generally to microscopy, more specifically to an apparatus for the dissipation of heat away from the illumination source of a microscope, and, even more particularly, to a heat sink assembly for a microscope.

### BACKGROUND

As is well known, a microscope is an optical instrument used to view, examine, and study very small objects. Many different types of microscopes have been developed since 1673, when Anton van Leeuwenhoek first magnified an object using a polished glass bead. These types include, but are not limited to: compound, stereo, confocal, inverted, and laser microscopes.

Microscopes have long used sources of light, both visible and non-visible, for the illumination of objects prior to their magnification. In early microscopes, plano and concave mirrors were used to guide light from external illumination sources, for example, the sun or candles, into the optical system. In modern microscopy, an object can be illuminated under many different lighting conditions. Some examples of lighting conditions include brightfield, darkfield, Köhler, oblique, and phase contrast illumination. The type of lighting condition used to illuminate an object is dependant upon the type of sample being observed, and the desired resultant image. For example, transparent sample images have poor contrast if illuminated with a brightfield source.

An inherent problem in the operation of modern microscope illumination systems is the necessity to dissipate, in a safe and harmless manner, the heat energy generated by the illumination systems. Agencies such as Underwriters Laboratory (UL) have determined maximum permissible surface temperatures for laboratory instruments. However, many light sources commonly used in microscopes create temperatures well above the permissible temperatures. For example, tungsten halogen bulbs can reach temperatures of 250° C. under normal operating conditions. If the heat generated by a light source is allowed to transfer directly through the microscope base, the temperature of the base surface may exceed the abovementioned maximum temperature.

Modern illumination systems require modem electronic circuits to regulate and control the delivery of light. The electronic components forming the illumination system control circuit are sensitive to heat. As a result, heating the control circuits with energy from the illumination source can adversely impact component life expectancy and illumination quality and consistency.

The emission of light from a microscope into the ambient surroundings also is undesirable. Photomicrography demands the suppression of ambient light to obtain a quality photomicrograph. Due to the requirement of air exchange for heat dissipation, an area on the microscope near the illumination source is typically vented. Unfortunately, in addition to air exchange, venting also may allow light to escape. The escaping light can enter the optical system and degrade image quality. Under some special circumstances, even laboratory overhead lighting must be suppressed prior to image capture. Therefore, it can be seen that any ambient light, even light which emanates from the base of the microscope, is undesirable during the image capture process.

Thus, given the aforementioned reasons, it can be seen there has been a longfelt need for a heat removal arrangement for a microscope illumination source capable of dissipating heat in a safe and effective manner and occluding air inlets to prevent illumination light egress.

### BRIEF SUMMARY OF THE INVENTION

The present invention broadly includes a heat sink assembly for a microscope having a baffle located proximate an air inlet of a microscope and a heat sink located proximate the baffle. The heat sink is operatively arranged to transfer heat from an illumination source for the microscope to air entering the microscope past the baffle.

A general object of the invention is to provide a means to transfer heat away from a microscope illumination source in a safe and effective manner.

Another object of the invention is to occlude light from a microscope illumination source from escaping through an air inlet of the microscope.

These and other objects, features, and advantages of the present invention will become readily apparent to those having ordinary skill in the art upon reading the detailed description of the invention in view of the drawings and appended claims.

### BRIEF DESCRIPTION OF THE DRAWINGS

The nature and mode of operation of the present invention will now be more fully described in the following detailed description of the invention taken with the accompanying drawing figures, in which:

FIG. 1 is a perspective view of a microscope;

FIG. 2 is a perspective view of the rear of the microscope;

FIG. 3 is a perspective view of the microscope with the base plate shown separately;

FIG. 4 is a magnified view of the encircled region shown in FIG. 3;

FIG. 5 is an exploded view of FIG. 4;

FIG. 6 is a cross-sectional view of the microscope, taken generally along line 6-6 of FIG. 1;

FIG. 7a is a magnified view of the encircled region shown in FIG. 6;

FIG. 7b is a cross-sectional view of the baffle plate, taken generally along line 7b-7b of FIG. 5;

FIG. 8 is a perspective view of the top-right side of the heat sink;

FIG. 9 is a perspective view of the bottom-left side of the heat sink;

FIG. 10 is a perspective view of the top-left side of the heat sink; and,

FIG. 11 is a perspective view of the bottom side of the heat sink.

### DETAILED DESCRIPTION OF THE INVENTION

It should be appreciated at the outset that while the present invention relates to a “Heat Sink Assembly for a Microscope”, the Assignees of the present Application for Patent have developed certain other improvements to microscopes described in United States Patent Applications entitled “Interchangeable Microscope Stage Drive Assembly”, “Releasable/Interchangeable Fine Focus Knob for a Microscope”, “Ergonomically Arranged Object Adjustment Controls”, “Shielded-Ergonomic Microscope Stages”, “Lamp Assembly for a Microscope” and “Means for Transporting a Microscope”, which applications are filed concurrently herewith by the Assignees of the present Application for Patent, which Applications are incorporated herewith by reference in their entireties.

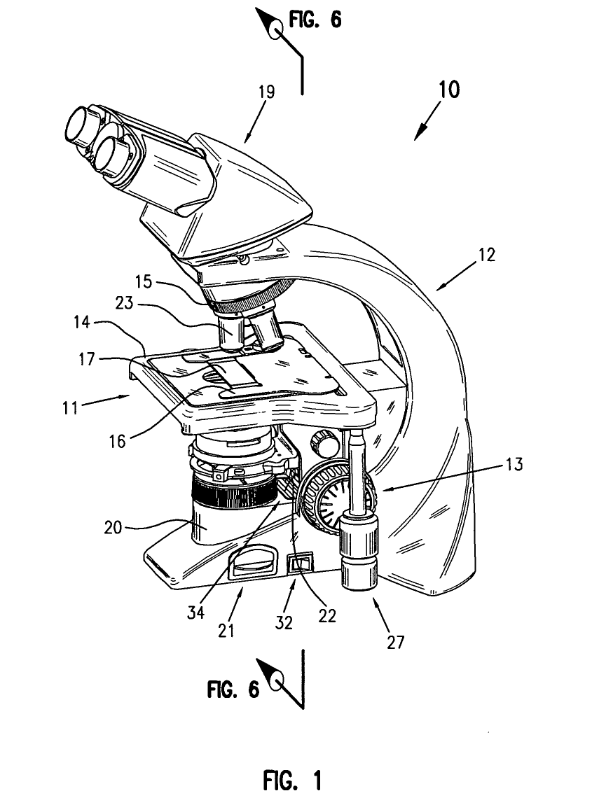

FIG. 1 is a perspective view of a microscope 10. Additionally, it should be appreciated that like drawing numbers on different drawing views identify identical structural elements of the invention. While the present invention is described with respect to what is presently considered to be the preferred embodiments, it is understood that the invention as claimed is not limited to the disclosed embodiments. In the description below, the terms “up,” “down,” “forward,” “backward,” “left”, “right”, and their derivatives, should be interpreted from the perspective of one viewing the microscope shown in FIG. 1. A conventional compound microscope 10 is shown in perspective view in FIG. 1. Although the invention is suitable for use with a variety of light microscopes, it is useful to review the basic microscope structure and function to appreciate the present invention.

Microscope 10 broadly comprises microscope stand 12 to which all the component pieces of the microscope are mounted. In the embodiment shown, the viewing body 19 is binocular (eyepieces not shown). Viewing body 19 is not particularly germane to the invention, which is suitable for use with a microscope configured with any type of viewing body, for example, monocular, binocular, trinocular, or video. Objective lenses 23 are mounted to rotatable turret 15. Microscope 10 further comprises interchangeable microscope stage system 11, fixedly secured to stand 12. Interchangeable microscope stage system 11 comprises slide mount 16, stage 14, and drive mechanism 27. Slide mount 16 is incorporated into stage system 11 and enables movement of slide 17, which holds a specimen to be viewed. Coarse and fine focus knobs 13 are rotatably mounted to stand 12. Rotating knobs 13 move stage 14 up and down, further moving slide 17 within the optical path of the microscope, allowing for focus at the specimen. By operating switch 32, the illumination source (not shown) of lamp assembly 21 is powered on and off. Integral to microscope stand 12 is air outlet 34. Air is permitted to pass through outlet 34 via the plurality of slots 22. Microscope stand illuminator housing 20 is operatively arranged to contain an illumination system (not shown).

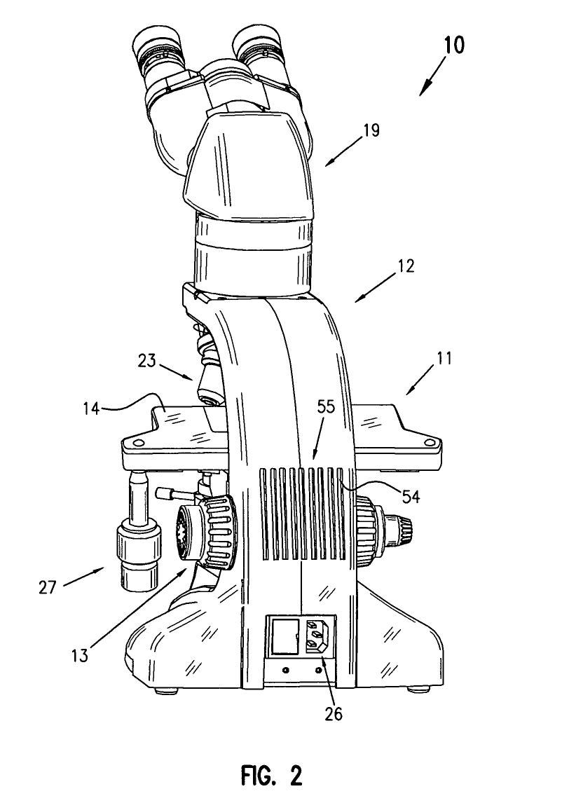

FIG. 2 is a perspective view of the rear of the microscope 10. Power inlet 26 is electrically connected to switch 32 and is configured to receive power from a wall socket (not shown). Air outlet 55 comprising the plurality of slots 54 is arranged to permit the egress of air from the volume contained within microscope stand 12.

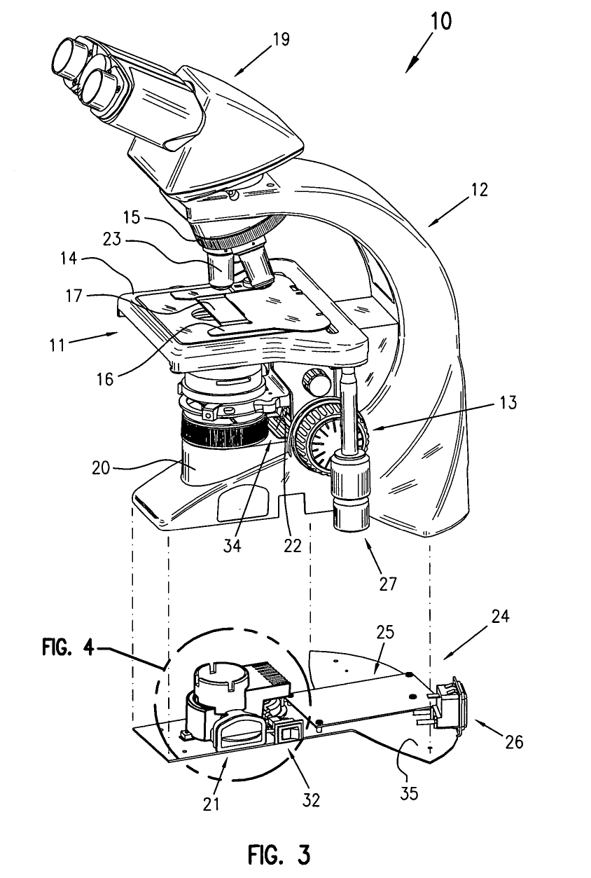

FIG. 3 is a perspective view of microscope 10 with base plate assembly 24 shown separately. Fixedly secured in the back area of base plate 35 is power inlet 26 and printed circuit board 25. Fixedly secured in the front area of base plate 35 is switch 32 and lamp assembly 21. The electrical wires connecting power inlet 26 to switch 32 are not shown.

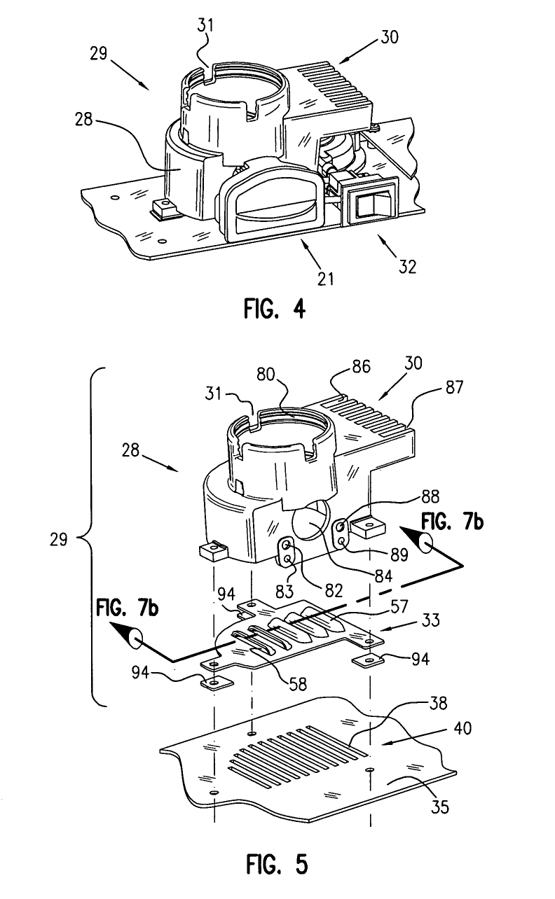

FIG. 4 is a magnified view of the encircled region shown in FIG. 3.

FIG. 5 is an exploded view diagram of FIG. 4. The following should be considered in light of FIGS. 4 and 5. FIG. 5 shows a present invention heat sink assembly 29. Heat sink assembly 29 includes heat sink 28 and baffle plate 33. Heat sink 28 dissipates heat energy generated by the illumination source (not shown) of lamp assembly 21. Base plate 35 includes air inlet 40, which has a plurality of slots 38. Baffle plate 33 comprises a plurality of slots 58. Slots 58 are each partially covered by a respective baffle 57. Air inlet 40 and slots 38 in base plate 35 and slots 58 and baffles 57 enable the flow of air into microscope stand 12, around heat sink 28, and out of microscope 10 through outlets 34 and 55 (see FIGS. 1 and 2).

Heat sink 28 has integrally mounted fins 30. Fins 30 include consecutive air gaps 87 and, between air gaps 87, fm surfaces 86. The increase in surface area for heat sink 28 due to fin surfaces 86 is largely responsible for the increased heat transfer efficiency of heat sink 28. Additionally, some heat is dissipated from heat sink 28 via airflow through slots 31.

Heat sink 28 also can function as an illumination source housing. In the embodiments shown, an illumination source is included. However, the features required to mount electrical sockets for a source and to position a source are shown. Aperture 84 permits the disposition of a source within heat sink 28. Holes 82 and 88 are operatively arranged to permit the accurate placement of a lamp assembly socket (not shown). Holes 83 and 89 are operatively arranged to fixedly secure the lamp assembly socket to heat sink 28.

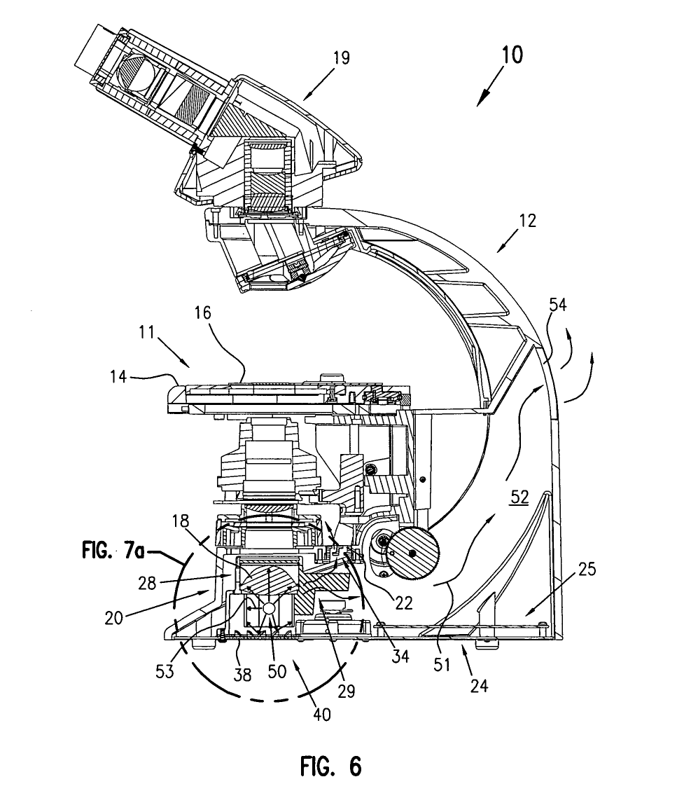

FIG. 6 is a cross-sectional view of microscope 10, taken generally along line 6-6 of FIG. 1.

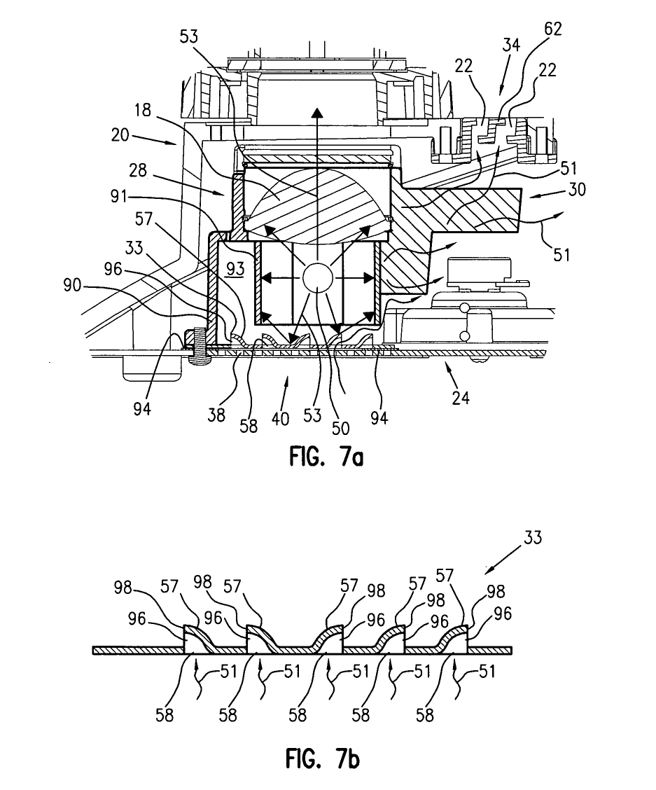

FIG. 7a is a magnified view of the encircled region shown in FIG. 6. The following should be viewed in light of FIGS. 5, 6, and 7a. Baffles 57 serve the dual purposes of deflecting and directing air stream 51 and blocking light from an illumination source in microscope 10. Thus, air stream 51 is deflected by baffles 57 and moves by and across heat sink 28. Then, heat from sink 28 is transferred to air stream 51 for subsequent removal via outlets 34 and 55. By deflecting air stream 51, baffles 57 create a more turbulent and less laminar airflow by and over heat sink 28. In general, turbulent airflows are more efficient than laminar airflows for heat transfer. Concurrently, the shape of baffles 57, which is further described below, in combination with a the relative positions of slots 58 and 38, blocks light emanating from bulb 50 and prevents this light from exiting through slots 38. That is, slots 38 and 58 and baffles 57 are aligned such that baffles 57 block the direct path through the slots for light emanating directly from bulb 50 or reflecting from surfaces of lamp assembly 21 or baffles 57. In the embodiments shown, the relative positions between slots 58 and 38 include a lateral displacement between slots 58 and 38.

Slots 38 are oriented in a left-to-right direction within base plate 35. However, it should be understood that the orientation of slots 38 is not critical to the present invention. In the embodiments shown, baffle plate 33 is oriented so that slots 58 are parallel to slots 38, that is, from left-to-right. However, in some embodiments (not shown), slots 58 are not parallel to slots 38. For example, in some embodiments, slots 58 are orthogonal to slots 38.

Bulb 50 is releasably secured and collector lens 18 is fixedly secured within heat sink 28. Collector lens 18 gathers light rays 53 and subsequently transmits rays 53 along the optical path (not shown) of microscope 10. Bulb 50 imparts heat energy to heat sink 28. Due to the direct and intimate contact of fins 30 with heat sink 28, heat from bulb 50 is efficiently conducted to fins 30. Then, air surrounding fins 30 is heated and subsequently rises within volume 52 of microscope stand 12. In this embodiment, as the air rises, it is permitted to escape through slots 54 and slots 22. The exiting air causes a negative pressure within volume 52. The negative pressure re-equilibrates with atmospheric pressure by drawing air in through air inlet 40. As noted above, air stream 51, entering via inlet 40, is disrupted by baffle plate 33, thereby creating a more turbulent airflow past heat sink 28. Thus, air stream 51 is drawn by and over heat sink 28 and fins 30 and convective heat transfer occurs between heat sink 28, fins 30, and air stream 51. Then, the heated air rises and exits through slots 22 or 54, effectively dissipating heat from heat sink 28.

As noted supra, maximum allowable surface temperatures for microscope 10 components, such as base plate 24 or illuminator housing 20 have been established. Since heat energy has the propensity to dissipate along the path of least resistance, more heat energy dissipates via heat sink 28 than transmits through base plate 24 or illuminator housing 20. Thus, the present invention helps maintain compliance with the abovementioned maximum surface temperatures. It is also desirable to minimize heat transfer to printed circuit board 25. The electronic components attached to board 25 and comprising the driving circuit for the illumination system (not shown) are thermally sensitive. As the temperatures of the components change, the lamp driving voltage generated by the circuit varies. This variance in driving voltage causes the illumination system to fluctuate, causing image degradation during capture. Therefore, transmitting heat energy through heat sink 28, rather than through base plate 24, maintains consistent illumination levels, and subsequently, improves the quality of captured images. Thus, heat sink 28 and baffle plate 33 safely and efficiently dissipate heat energy from microscope 10.

In some embodiments, an insulating layer is placed between baffle plate 33 and mounting plate 35 to thermally separate baffle plate 33 from base plate 35. For example, in FIGS. 5 and 7a, insulating layer 94 is shown between baffle plate 33 and mounting plate 35. In the embodiment shown in FIG. 5, layer 94 consists of three separate pieces. However, it should be understood that the number and size of the pieces making up layer 94 can be varied within the spirit and scope of the invention as claimed. Layer 94 can be formed from any suitable insulating material known in the art. For example, in some embodiments, layer 94 is formed from cork.

Air outlet 34 comprises consecutively located slots 22, separated by air outlet material 62. Air stream 51, after passing by and over fins 30, is permitted to exit through air vent 34 or outlet 55 (not shown). It should be understood that the configuration of outlet 34 is not particularly germane to the present invention.

FIG. 7b is a cross-sectional view of baffle plate 33, taken generally along line 7b-7b of FIG. 5. Each baffle 57 forms an opening 96, defined by an upper edge 98 and the surface of baffle plate 33. In the embodiments shown, slots 58 have a curved, or arcuate, cross-section. This cross-section can be a smooth curve, as shown in FIG. 7b, or a segmented curve (not shown). Although a particular cross-sectional shape is shown in FIG. 7b, it should be readily apparent to those having ordinary skill in the art that other cross-sectional shapes are possible, and that such shapes are within the spirit and scope of the invention as claimed. For example, essentially linear cross-sectional shapes, or combinations of linear and curved shapes also are included in the spirit and scope of the invention as claimed.

In FIG. 7b, slots 57 are arranged such that openings 96 face in one of two opposite directions. That is, the two left-most openings 96 face left and the three right-most openings 96 face right on the sheet for FIG. 7b. It should be understood that this is only one possible arrangement for the openings. For example, the openings could be arranged to all face one direction (not shown). Also, the openings facing in different directions can be configured differently than as shown in FIG. 7b. For example, openings 96 can be arranged in alternating patterns, for example, orienting every other opening in one direction, and orienting the remaining openings in an opposite direction. It is understood that other groupings and patterns of openings also are included in the spirit and scope of the invention as claimed.

Baffles 57 disrupt air stream 51 as described above. In FIGS. 7a and 7b, the pattern of openings 94 introduces air into the volume contained within microscope stand 12 in two different directions. That is, using sheet 6/8 as a frame of reference, air is directed to the left-hand side of the volume by the two left-most openings 92 and to the right-hand side of the volume by the three right-most openings 92. Diverting the entering air in these two opposite directions helps ensure a more uniform and widely distributed flow of air by and over heat sink 28.

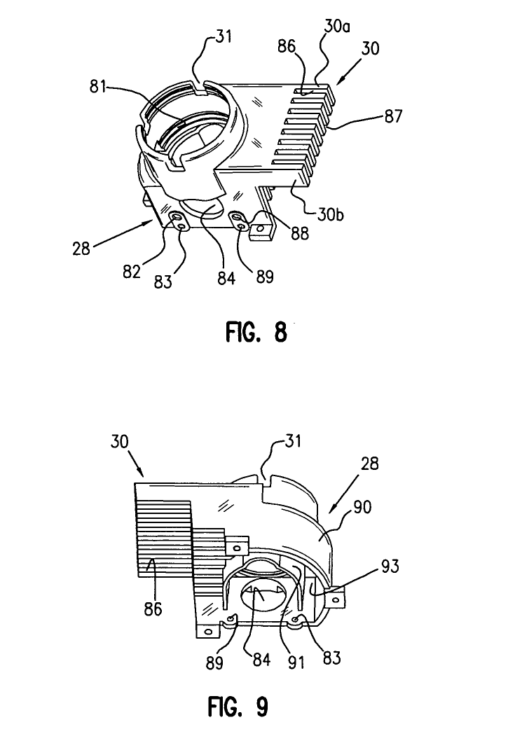

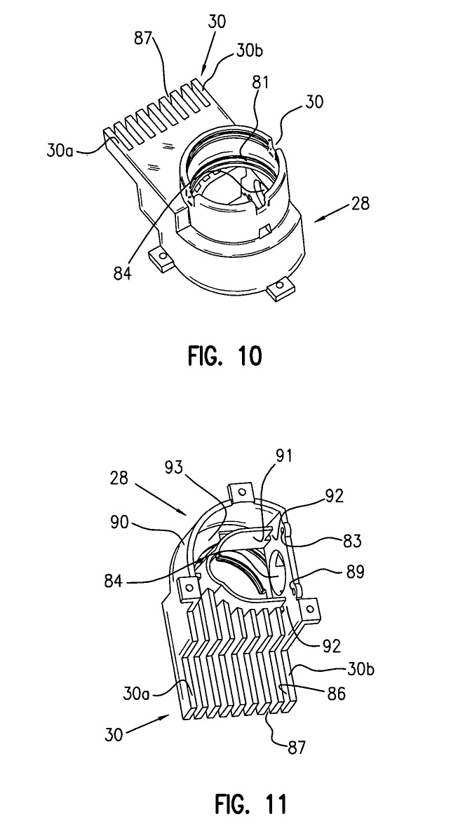

FIGS. 8 through 11 are perspective views of the top-right side, the bottom-left side, the top-left side, and the bottom side, respectively, of heat sink 28. Collector lens 18 (not shown) is fixedly secured to surface 81. Slotted openings 31 are operatively arranged to permit the flow of air around collector lens 18, thus facilitating heat transfer. Holes 82 and 88 are operatively arranged to guide the placement of a lamp assembly socket (not shown). Holes 83 and 89 are operatively arranged to permit the rigid affixing of the lamp assembly socket. Aperture 84 is oriented to permit the installation of bulb 50 (not shown) via the releasable attachment of lamp socket 21 (not shown). Outer wall 90 and inner wall 91 are concentrically arranged with air gap 93 forming a thermal insulating layer between the walls. In the region of holes 83 and 89, inner wall 91 and outer wall 90 are separated by air gap 92. Air gap 92 is operatively arranged to prevent the transmission of heat from inner wall 91 to outer wall 90, and subsequently from the lamp assembly socket (not shown) mounted to holes 83 and 89.

Fins 30a and 30b are integral to outer wall 90. The remaining fins 30 are integral to inner wall 91. It should be understood, however, that other configurations of fins 30 with walls 90 and 91 are possible, and that such configurations are within the spirit and scope of the present invention as claimed.

Thus, it is seen that the objects of the present invention are efficiently obtained, although modifications and changes to the invention should be readily apparent to those having ordinary skill in the art, which modifications are intended to be within the spirit and scope of the invention as claimed. It also is understood that the foregoing description is illustrative of the present invention and should not be considered as limiting. Therefore, other embodiments of the present invention are possible without departing from the spirit and scope of the present invention.

What is claimed:

1. A microscope comprising:
an illumination source;
a heat sink assembly surrounding said illumination source; and,
a plurality of fins formed at said heat sink assembly and operatively arranged to conduct heat away from said illumination source and to transfer said heat to air passing by or over said assembly.

2. The microscope recited in claim 1 wherein said heat sink further comprises an inner wall and an outer wall separated by an air gap.

3. The microscope recited in claim 2 wherein a first fin from said plurality of fins is connected to said outer wall and a second fin from said plurality of fins is connected to said inner wall.

4. The microscope recited in claim 1 further comprising:
an air inlet; and,
wherein said heat sink assembly further comprises a baffle located proximate said air inlet and operatively arranged to deflect air entering said microscope via said inlet and to occlude the emanation of light from said illumination source through said air inlet.

5. The microscope recited in claim 4 wherein said heat sink assembly further comprises a baffle plate with a baffle slot;
wherein said baffle is disposed on said baffle plate in substantial alignment with said baffle slot; and,
wherein said baffle plate overlies said air inlet.

6. The microscope recited in claim 5 wherein said baffle plate further comprises a first plurality of baffles and a plurality of corresponding baffle slots.

7. The microscope recited in claim 6 wherein each baffle in said first plurality of baffles has a cross-section with an arcuate shape.

8. The microscope recited in claim 6 wherein each baffle in said first plurality of baffles forms an opening, between an edge of said each baffle and said baffle plate, disposed in a first direction.

9. The microscope recited in claim 6 wherein said first plurality of baffles is divided into second and third pluralities of baffles; and,
wherein each baffle in said second plurality of baffles forms an opening, between an edge of said each baffle and said baffle plate, disposed in a first direction and each baffle in said third plurality of baffles forms an opening, between an edge of said each baffle and said baffle plate, disposed in a second direction, opposite said first direction.

10. The microscope recited in claim 9 wherein said second plurality of baffles is disposed to direct air entering said microscope in said first direction and said third plurality of baffles is disposed to direct air entering said microscope in said second direction.

11. The microscope recited in claim 6 wherein said air inlet further comprises a plurality of substantially parallel inlet slots; and,
wherein said plurality of corresponding baffle slots is disposed substantially parallel to said plurality of inlet slots.

12. The microscope recited in claim 6 wherein said air inlet further comprises a plurality of substantially parallel inlet slots; and,
wherein said plurality of corresponding baffle slots is disposed substantially orthogonal to said plurality of inlet slots.

13. The microscope recited in claim 5 further comprising:
a base plate;
wherein said air inlet is disposed in said base plate; and,
wherein said baffle plate is attached to said base plate and a thermally insulating layer is provided between said base plate and said baffle plate.

14. The microscope recited in claim 4 further comprising:
an air outlet; and,
wherein said heat sink assembly is operatively arranged to induce airflow into said air inlet, across said heat sink, and through said air outlet.

15. A microscope comprising:
an air inlet; and,
a baffle assembly located proximate said air inlet and operatively arranged to divert air entering said microscope via said inlet and to occlude the emanation of light from said microscope through said air inlet.

16. The microscope recited in claim 15 wherein said baffle assembly further comprises a baffle located proximate said air inlet.

17. The microscope recited in claim 16 wherein said baffle assembly further comprises a baffle plate with a baffle slot; and,
wherein said baffle is disposed on said baffle plate in substantial alignment with said baffle slot.

18. The microscope recited in claim 17 wherein said baffle plate further comprises a first plurality of baffles and a plurality of corresponding baffle slots.

19. The microscope recited in claim 18 wherein each baffle in said first plurality of baffles has a cross-section with an arcuate shape.

20. The microscope recited in claim 18 wherein each baffle in said first plurality of baffles forms an opening, between an edge of said each baffle and said baffle plate, disposed in a first direction.

21. The microscope recited in claim 18 wherein said first plurality of baffles is divided into second and third pluralities of baffles; and,
wherein each baffle in said second plurality of baffles forms an opening, between an edge of said each baffle and said baffle plate, disposed in a first direction and each baffle in said third plurality of baffles forms an opening, between an edge of said each baffle and said baffle plate, disposed in a second direction, opposite said first direction.

22. The microscope recited in claim 21 wherein said second plurality of baffles is disposed to direct air entering said microscope in said first direction and said third plurality of baffles is disposed to direct air entering said microscope in said second direction.

23. The microscope recited in claim 18 wherein said air inlet further comprises a plurality of substantially parallel inlet slots; and,
wherein said plurality of corresponding baffle slots is disposed substantially parallel to said plurality of inlet slots.

24. The microscope recited in claim 18 wherein said air inlet further comprises a plurality of substantially parallel inlet slots; and,
wherein said plurality of baffle slots is disposed substantially orthogonal to said plurality of inlet slots.

25. The microscope recited in claim 17 further comprising:
a base plate;
wherein said air inlet is disposed in said base plate; and,
wherein said baffle plate is mounted to said base plate and a thermally insulating layer is provided between said base plate and said baffle plate.

26. The microscope recited in claim 15 further comprising:
an illumination source;
wherein said baffle assembly further comprises, proximate said illumination source, a heat sink having a plurality of fins operatively arranged to conduct heat away from said illumination source and to transfer said heat to air passing over said heat sink.

27. The microscope recited in claim 26 wherein said heat sink further comprises an inner wall and an outer wall separated by an air gap.

28. The microscope recited in claim 27 wherein a first fin from said plurality of fins is connected to said outer wall and a second fin from said plurality of fins is connected to said inner wall.

29. The microscope recited in claim 26 further comprising:
an air outlet; and,
wherein said baffle assembly is operatively arranged to induce airflow into said air inlet, across said heat sink, and through said air outlet.

30. A heat sink assembly for a microscope comprising:
a baffle located proximate an air inlet of said microscope and operatively arranged to deflect air that enters said microscope via said inlet; and,
a heat sink located proximate said baffle and operatively arranged to transfer heat to said air.

31. The heat sink assembly recited in claim 30 wherein said heat sink further comprises an inner wall and an outer wall separated by an air gap.

32. The heat sink assembly recited in claim 30 wherein said heat sink further comprises a plurality of fins.

33. The heat sink assembly recited in claim 32 wherein said heat sink further comprises an inner wall and an outer wall separated by an air gap.

34. The heat sink assembly recited in claim 33 wherein a first fin from said plurality of fins is connected to said outer wall and a second fin from said plurality of fins is connected to said inner wall.

35. The heat sink assembly recited in claim 30 wherein said microscope further comprises an illumination source; and,
wherein said baffle occludes the emanation of light from said illumination source through said inlet.

36. The heat sink assembly recited in claim 35 further comprising:
a baffle plate with a baffle slot;
wherein said baffle is disposed on said baffle plate in substantial alignment with said baffle slot; and,
wherein said baffle plate overlies said air inlet.

37. The heat sink assembly recited in claim 36 wherein said baffle plate further comprises a plurality of baffles and a plurality of corresponding baffle slots.

38. The microscope recited in claim 37 wherein each baffle in said first plurality of baffles has a cross-section with an arcuate shape.

39. The microscope recited in claim 37 wherein each baffle in said first plurality of baffles forms an opening, between an edge of said each baffle and said baffle plate, disposed in a first direction.

40. The microscope recited in claim 37 wherein said first plurality of baffles is divided into second and third pluralities of baffles; and,
wherein each baffle in said second plurality of baffles forms an opening, between an edge of said each baffle and said baffle plate, disposed in a first direction and each baffle in said third plurality of baffles forms an opening, between an edge of said each baffle and said baffle plate, disposed in a second direction, opposite said first direction.

41. The microscope recited in claim 40 wherein said second plurality of baffles is disposed to direct air entering said microscope in said first direction and said third plurality of baffles is disposed to direct air entering said microscope in said second direction.

42. The microscope recited in claim 37 wherein said air inlet further comprises a plurality of substantially parallel inlet slots; and,
wherein said plurality of corresponding baffle slots is disposed substantially parallel to said plurality of inlet slots.

43. The microscope recited in claim 37 wherein said air inlet further comprises a plurality of substantially parallel inlet slots; and,
wherein said plurality of baffle slots is disposed substantially orthogonal to said plurality of inlet slots.

44. The heat sink assembly recited in claim 36 wherein said microscope further comprises a base plate; and,
wherein said air inlet is disposed in said base plate and said baffle plate is mounted to said base plate.

45. The heat sink assembly recited in claim 44 wherein a thermally insulating layer is provided between said base plate and said baffle plate

46. The heat sink assembly recited in claim 30 wherein said microscope further comprises an air outlet; and,
wherein said heat sink assembly is operatively arranged to induce airflow into said air inlet, across said heat sink, and through said air outlet.

47. The heat sink assembly recited in claim 30 wherein said microscope further comprises an illumination source; and,
wherein said heat sink further comprises an aperture operatively arranged to receive said illumination source.

48. The heat sink assembly recited in claim 30 wherein said microscope further comprises a collector lens; and,
wherein said heat sink further comprises means to mount said collector lens.

49. The heat sink assembly recited in claim 30 wherein said microscope further comprises a microscope lamp assembly socket; and,
wherein said heat sink further comprises means to mount said microscope lamp assembly socket.

50. The heat sink assembly recited in claim 30 wherein said microscope further comprises a microscope lamp assembly; and,
wherein said heat sink further comprises means to guide said microscope lamp assembly.
